(19) United States
(12) Patent Application Publication
(10) Pub. No.: US 2011/0017561 A1
(43) Pub. Date: Jan. 27, 2011

(54) VIBRATION DAMPING APPARATUS

(75) Inventor: Makoto TANAKA, Tokyo (JP)

Correspondence Address: OLIFF & BERRIDGE, PLC, P.O. BOX 320850, ALEXANDRIA, VA, 22320-4850, US

(73) Assignee: TANAKA SEISHIN KOZO LABORATORY INC., Tokyo (JP)

(21) Appl. No.: 12/835,336

(22) Filed: Jul. 13, 2010

(30) Foreign Application Priority Data
Jul. 24, 2009 (JP) 2009-172956

(51) Int. Cl. F16F 7/00; F16F 7/10

(52) U.S. Cl. 188/378; 188/266

(57) ABSTRACT

A vibration damping apparatus has a first looped rope member and a second looped rope member each having a loop portion formed of a rope member in a loop shape, the rope member being formed by twining a plurality of linear members. Further, the vibration damping apparatus has a first base member and a second base member disposed in an up-and-down of the first looped rope member. The first looped rope member is fixed to the first base member and the second base member with the loop portion standing up. The second looped rope member is fixed to an intersecting portion, in one of the first base member and the second base member, intersecting a fixing portion of the first looped rope member with the loop portion standing up.

### CROSS-REFERENCE TO RELATED APPLICATIONS

This application is based upon and claims the benefit of priority from Japanese Patent Application NO. 2009-172956, filed Jul. 24, 2009, the entire contents of which are incorporated herein by reference.

### BACKGROUND

1. Field of the Invention

The present invention relates to a vibration damping apparatus suppressing a vibration of a structure.

2. Related Background Art

A stationary structure such as a wooden building, a multi-story building, an industrial machine, a bridge, or an elevated road or railway, and a mobile structure such as a vehicle, an airplane, or a ship vibrate upon reception of external force due to an earthquake, strong wind, traveling of a vehicle, or the like, according to this external force. Further, the mobile structure and the industrial machine vibrate by various factors while moving or operating.

Conventionally, there have been known techniques aiming at suppressing a vibration generated in such a structure. For example, there is known an apparatus called TMD (Tuned Mass Damper) as an apparatus which suppresses a vibration in a wooden building or a multi-story building due to an earthquake, strong wind, or the like. This apparatus is constituted of a weight and an elastic support member supporting this weight in a manner to allow the weight to vibrate, and the mass of the weight and the spring constant of the elastic support member are adjusted so that the vibration cycle of the weight substantially equals to the inherent vibration cycle of the structure. With respect to such a TMD, for example, Patent Document 1 (Japanese Patent Application Laid-open No. H4-49387) discloses an apparatus structured such that each of plural weights vibrates at the same vibration cycle as the inherent vibration cycles of plural orders of the structure.

Besides that, as a technique aiming at suppressing a vibration generated in the structure, there have been techniques disclosed in Patent Documents 2, 3, 4.

Patent Document 2 (Japanese Patent Application Laid-open No. H7-324518) discloses a pendulum-type control apparatus in which a pendulum and an inclined surface supporting the weight of the pendulum are disposed symmetrically.

Further, Patent Document 3 (Patent Publication No. 3483535) discloses a vibration damping structure in which a couple of vibration damping apparatuses are installed corresponding to the ridge structure of a roof. Patent Document 4 (Japanese Patent Application Laid-open No. 2000-283227) discloses a vibration decreasing apparatus in the form of a volute spring.

### SUMMARY OF THE INVENTION

The above-described conventional arts enable to suppress a vibration generated in a stationary structure by an earthquake, strong wind, or the like and a vibration generated in a mobile structure.

However, the apparatuses disclosed in Patent Documents 1, 2, 3 are just capable of suppressing a two-dimensional vibration in a horizontal direction (hereinafter referred to as a “horizontal vibration”) of a structure moving along a horizontal plane, due to the structures of members for damping a vibration, and it is quite difficult for them to suppress a vibration in a vertical direction (hereinafter referred to as a “vertical vibration”) of a structure moving along a height direction.

Further, the apparatus disclosed in Patent Document 4 is structured such that a volute spring for damping a vibration extends and contracts along an axial direction, and thus is only capable of suppressing a vibration along the axial direction.

In short, in the above-described conventional arts, there are problems that the direction of the vibration is limited, and that the expected vibration suppressing effect can be obtained when the structure of the apparatus corresponds to the vibration, but otherwise the expected vibration suppressing effect cannot be obtained.

However, a vibration generated in a stationary structure or a mobile structure by an earthquake, a vibration generated in a traveling vehicle or the like, and a vibration generated in a bridge or the like accompanying traveling of a vehicle are a three-dimensional vibration in which a horizontal vibration and a vertical vibration are combined, and may further be a vibration (hereinafter referred to as an “irregular three-dimensional vibration”) which a direction of the structure to move is irregular. A vibration generated in a stationary structure or a mobile structure by an earthquake in particular is often the irregular three-dimensional vibration, and thus it is difficult to precisely adapt the structure of the apparatus for suppressing a vibration to the vibration by an earthquake.

Thus, in the conventional arts, there are problems that the range of vibrations which can be suppressed is limited, and that it is quite difficult to suppress the irregular three-dimensional vibration.

The present invention is made to solve the above-described problems, and it is an object of the present invention, in a vibration damping apparatus suppressing a vibration of a structure, to enlarge the range of vibrations which can be suppressed and to enable to suppress the irregular three-dimensional vibration.

To solve the above problems, the present invention is a vibration damping apparatus, including: a first looped rope member and a second looped rope member each having a loop portion formed of a rope member in a loop shape, the rope member being formed by twining a plurality of linear members; and a first base member and a second base member disposed in an up-and-down of the first looped rope member, wherein the first looped rope member is fixed to the first base member and the second base member with the loop portion standing up, and wherein the second looped rope member is fixed to an intersecting portion, in one of the first base member and the second base member, intersecting a fixing portion of the first looped rope member with the loop portion standing up.

In this vibration damping apparatus, since the first looped rope member is fixed to the first base member and the second base member which are disposed in an up-and-down of it, external force which displaces relative positions of the first base member and the second base member in a horizontal direction is absorbed by the first looped rope member. Further, since the second looped rope member is fixed to the intersecting portion of one of the first base member and the second base member, external force which displaces relative positions of the first base member and the second base member in the vertical direction is absorbed by the second looped rope member by, for example, fixing the second looped rope member to the other of the first base member and the second base member.

It is preferable that the above-described vibration damping apparatus further includes a weight structured to be attachable to and detachable from the one of the first base member and the second base member to which the second looped rope member is fixed.

By having the weight as described above, the weight of the vibration damping apparatus is able to be adjusted and an inherent vibration cycle is able to be adjusted.

Further, the present invention provides a vibration damping apparatus, including: a first looped rope member and a second looped rope member each having an loop portion formed of a rope member in a loop shape, the rope member being formed by twining a plurality of linear members; a first base member disposed on a lower side of the first looped rope member; a second base member disposed on an upper side of the first looped rope member; a first wall member formed so as to intersect the first base member on a circumferential edge portion of the first base member; a second wall member formed so as to intersect the second base member on a circumferential edge portion of the second base member; and a weight mounted on the second base member inside of the second wall member, wherein the first looped rope member is fixed to the first base member and the second base member with the loop portion standing up, and wherein the second looped rope member is fixed to the first wall member and the second wall member with the loop portion standing up.

In this vibration damping apparatus, since the first looped rope member is fixed to the first base member and the second base member disposed on the upper side of the first base member, external force which displaces relative positions of the first base member and the second base member in the horizontal direction is absorbed mainly by the first looped rope member. Further, since the second looped rope member is fixed to the first wall member and the second wall member, external force which displaces relative positions of the first wall member and the second wall member in the vertical direction is absorbed mainly by the second looped rope member.

In the above-described vibration damping apparatus, it is preferable that an inclination angle between a straight line, which connects a first fixing position of the second looped rope member to the first wall member and a second fixing position of the second looped rope member to the second wall member, and a horizontal plane is set in a predetermined range.

In this manner, damping force in the horizontal direction and damping force in the vertical direction by the vibration damping apparatus are exhibited more effectively.

Further, the present invention provides a vibration damping apparatus, including: a first looped rope member and a second looped rope member each having a loop portion formed of a rope member in a loop shape, the rope member being formed by twining a plurality of linear members; and a first base member and a second base member disposed in an up-and-down of the first looped rope member, wherein the first looped rope member is fixed to the first base member and the second base member with the loop portion standing up, and wherein the second looped rope member is fixed to a circumferential edge portion of one of the first base member and the second base member with the loop portion extending out and standing up.

Also in this vibration damping apparatus; external force which displaces relative positions of the first base member and the second base member in the horizontal direction is absorbed by the first looped rope member. Further, external force which displaces relative positions of the first base member and the second base member in the vertical direction is absorbed by the second looped rope member by, for example, fixing the second looped rope member to the other of the first base member and the second base member.

In the any above-described vibration damping apparatus, it is preferable that the first looped rope member and the second looped rope member are each formed in a helical shape having a plurality of the loop portions.

In this structure, the first looped rope member and the second looped rope member have elasticity.

Further, in the any above-described vibration damping apparatus, it is preferable that a plurality of the second looped rope members disposed at equal intervals.

In this structure, external force which displaces relative positions of the first wall member and the second wall member in the vertical direction is able to be absorbed by the second looped rope members in a balanced manner.

Further, in the any above-described vibration damping apparatus, it is preferable that the weight is constituted of a plurality of metal plates having same shapes and having depressions and projections formed in a surface.

In this structure, the weight is able to be adjusted quantitatively by changing the number of weights. Moreover, the depression and projection of respective weight become bite each other, thereby preventing the weights from sliding.

As explained above in detail, according to the present invention, it is possible that the range of vibrations which can be suppressed is enlarge and irregular three-dimensional vibration is able to be suppressed in a vibration damping apparatus suppressing a vibration of a structure.

The present invention will be more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a perspective view illustrating an example of a vibration damping apparatus according to a first embodiment of the present invention;

FIG. 2 is an exploded perspective view illustrating an example of the vibration damping apparatus according to the first embodiment of the present invention;

FIG. 3 is a plan view of a lower unit constituting the vibration damping apparatus in FIG. 1;

FIG. 4 (a) is a side view illustrating an example of a helical structure body and a support plate, and (b) is a front view of the helical structure body and the support plate;

FIG. 5 is a sectional view illustrating an example of a rope member;

FIG. 6 is a sectional view taken along the line 6-6 in FIG. 3;

FIG. 7 is a plan view of an upper unit constituting the vibration damping apparatus in FIG. 1;

FIG. 8 is a front view of an upper unit constituting the vibration damping apparatus in FIG. 1;

FIG. 9 is a sectional view taken along the line 9-9 in FIG. 7;

FIG. 10 (a) is a perspective view illustrating an example of a weight, (b) is a perspective view illustrating another weight;

FIG. 11 is a sectional view taken along the line 11-11 in FIG. 1;

FIG. 12 is a sectional view of an enlarged essential part of FIG. 11;

FIG. 13 (a) is a plan view illustrating a base member and a wire spring according to a modified example, which are partially omitted, and (b) is a perspective view illustrating a wire spring according to the modified example;

FIG. 14 (a) is a plan view illustrating a base member and wire springs according to another modified example, (b) is a plan view illustrating a base member and wire springs according to still another modified example, and (c) is a perspective view illustrating a base member to which four wire rings are fixed;

FIG. 15 is a perspective view illustrating a wooden building frame and a vibration damping apparatus according to an example;

FIG. 16 is a perspective view illustrating a stationary structure and a vibration damping apparatus according to another example;

FIG. 17 is a perspective view illustrating a wooden building frame, a stationary structure, and a vibration damping apparatus according to another example;

FIG. 18 is a perspective view illustrating the case where dampers are provided in FIG. 16;

FIG. 19 is a perspective view illustrating the case where dampers are provided in FIG. 17;

FIG. 20 is a plan view illustrating an example of the vibration damping apparatus according to a second embodiment of the present invention;

FIG. 21 is a plan view illustrating an example of the vibration damping apparatus according to a third embodiment of the present invention;

FIG. 22 illustrates an example of the vibration damping apparatus according to a fourth embodiment of the present invention, in which (a) is a plan view, and (b) is a sectional view taken along the line b-b;

FIG. 23 illustrates an example of the vibration damping apparatus according to a fifth embodiment of the present invention, in which (a) is a sectional view of a vibration damping apparatus 90, and (b) is a sectional view of a vibration damping apparatus 95;

FIG. 24 is a chart illustrating experimental results performed in the example of FIG. 15; and

FIG. 25 illustrates a modified example of the vibration damping apparatus according to a fourth embodiment of the present invention, in which (a) is a sectional view similar with FIG. 22 (b), and (b) is a side elevation view with a part thereof omitted.

### DETAILED DESCRIPTION OF THE EMBODIMENTS

In the following, embodiments of the present invention will be described with reference to the drawings. Note that the same components will be referred to with the same numerals or letters, while omitting their overlapping descriptions.

### First Embodiment

### Constitution of Vibration Damping Apparatus

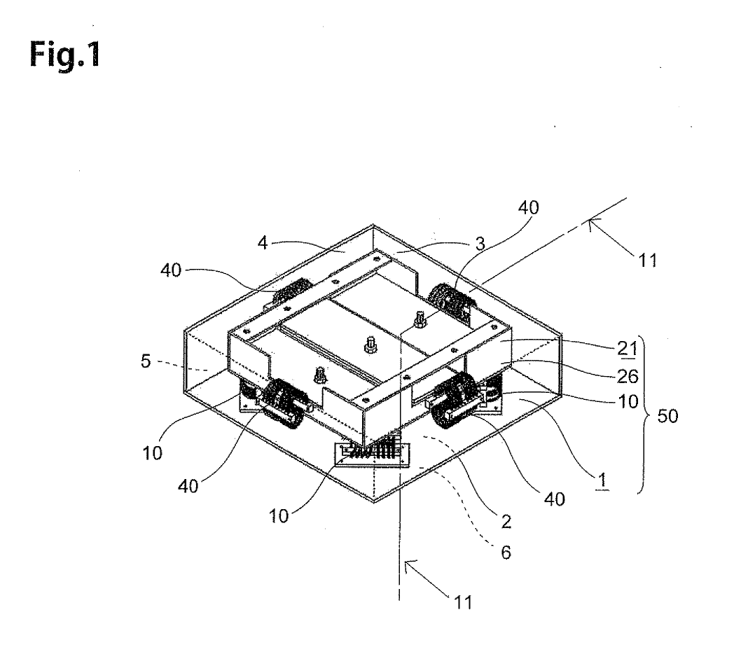

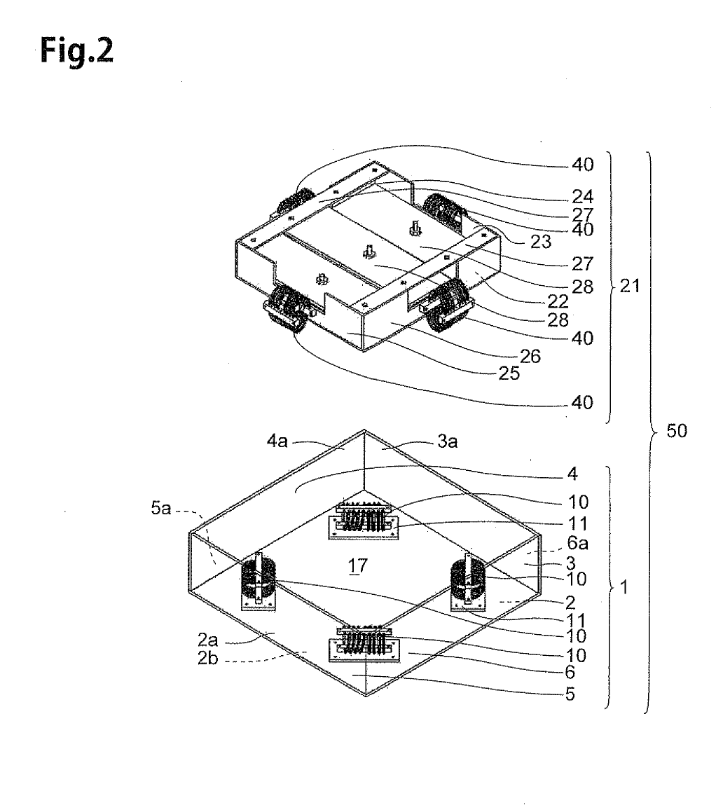

The constitution of a vibration damping apparatus according to a first embodiment of the present invention will be described with reference to drawings. FIG. 1 is a perspective view illustrating a constitution of a vibration damping apparatus 50 according to a first embodiment of the present invention, and FIG. 2 is an exploded perspective view illustrating a constitution of the vibration damping apparatus 50. As illustrated in FIG. 1, FIG. 2, the vibration damping apparatus 50 has a lower unit 1 and an upper unit 21.

The lower unit 1 has a base member 2, four wall members 3, 4, 5, 6, four helical structure bodies 10, and four support plates 11.

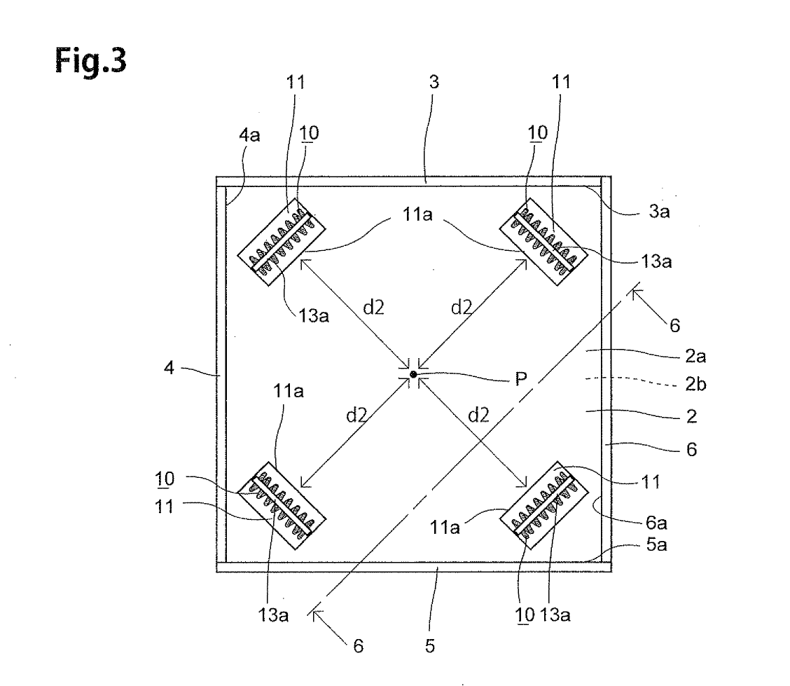

The base member 2 is a plate formed in a square shape using metal such as steel and has a flat front face 2a and a flat rear face 2b, as illustrated in detail in FIG. 2 and FIG. 3. This base member 2 is a first base member in the present invention and constitutes a bottom portion of the vibration damping apparatus 50. When the vibration damping apparatus 50 is installed in a structure such as a wooden building, the rear face 2b of the base member 2 comes in contact with this structure.

The wall members 3, 4, 5, 6 are first wall members in the present invention, and are plates formed in a rectangular shape using metal such as steel similarly to the base member 2. The wall members 3, 4, 5, 6 have equal heights and thicknesses, and are fixed to a circumferential edge portion of the base member 2 so that respective front faces 3a, 4a, 5a, 6a orthogonally intersect the front face 2a.

The wall members 3, 4, 5, 6 and the base member 2 form a space 17 for housing the upper unit 21. The lower unit 1 according to this embodiment has a structure in which the wall members 3, 4, 5, 6 are fixed to the base member 2. In the lower unit 1, the base member 2 and the wall members 3, 4, 5, 6 are separate members. However, the lower unit 1 may have a box-like structure in which the wall members 3, 4, 5, 6 are formed on the circumferential edge portion of the base member 2 and hence both of them are integrated. In this case, this box-like structure is the base member.

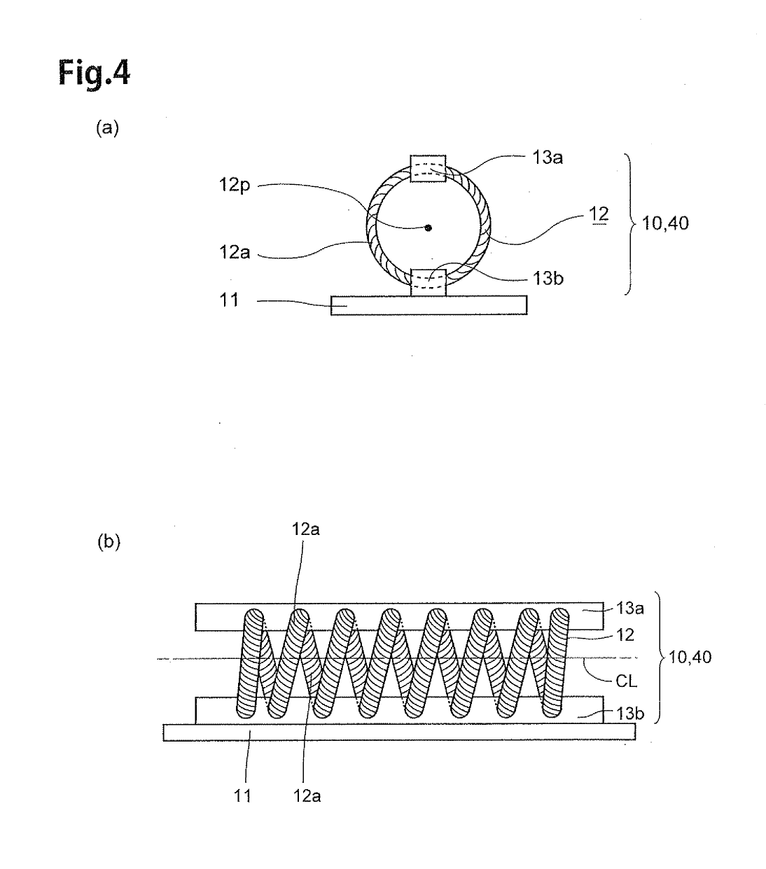

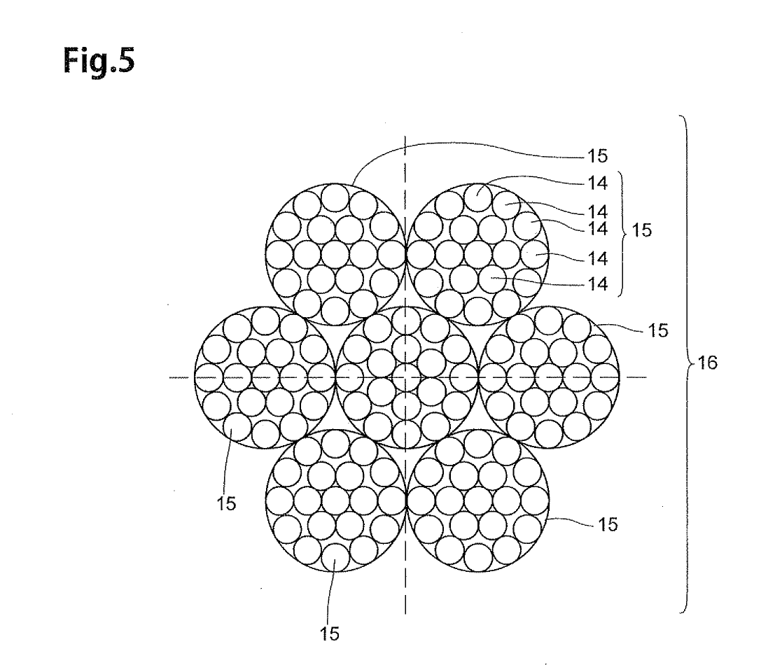

The helical structure bodies 10 each have a wire spring 12 and rod members 13a, 13b as illustrated in detail in FIG. 4 (a), (b). The wire spring 12 is a first looped rope member in the present invention and has a plurality of loop portions 12a, and is formed entirely in a helical shape. Each loop portion 12a is formed of a rope member 16, which is illustrated in detail in FIG. 5, in a substantially circular ring shape. The rope member 16 is an elastic member having high elasticity, and thus the loop portion 12a exhibits force of restitution to return to the original shape when a change in shape occurs such as changing from a circular shape to an elliptic shape, for example.

The rope member 16 is formed by twining a plurality (nineteen in FIG. 5) of linear members 14 made of steel, stainless steel, or the like with a circular cross section to make a unit rope member 15, and further twining and twisting a plurality (seven in FIG. 5) of such unit rope members 15. The rope member 16 according to this embodiment is a steel rope and has high elasticity. In addition, in the rope member 16 illustrated in FIG. 5, 133 linear members 14 in total are twined.

Each of the rod members 13a, 13b is a member with a square cross section and flat outside faces. In the rod members 13a, 13b, a plurality of through holes are formed at regular intervals along a longitudinal direction. The rod members 13a, 13b are integrated with the wire spring 12 by inserting the loop portions 12a of the wire spring 12 through their respective through holes. In the loop portions 12a, only portions opposing each other across a center 12p (these portions are also referred to as opposing portions) are inserted through the rod members 13a, 13b. Further, the rod members 13a, 13b are disposed at positions opposing each other across the center 12p of the loop portions 12a, and are in parallel with a center axis CL (see FIG. 4 (b)) of the wire spring 12.

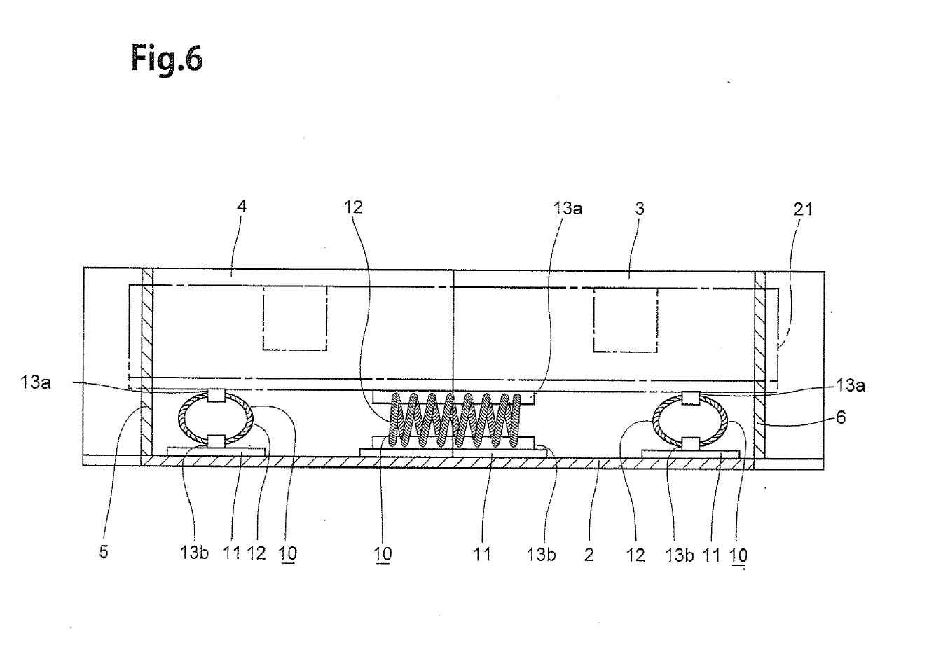

By fixing the rod member 13b to a support plate 11, the respective loop portions 12a stand up substantially orthogonally to the support plate 11. Only one of the two opposing portions of each loop portion 12a is in contact with the support plate 11 via the rod member 13b. By fixing this support plate 11 to the front face 2a of the base member 2, the wire spring 12 is fixed to the base member 2 with the loop portions 12a standing up. Further, the rod member 13a is fixed to a base member 22 which will be described later, and thus the wire spring 12 is also fixed to the base member 22 with the loop portions 12a standing up. Accordingly, a load in a vertical direction from the upper unit 21 is applied to the helical structure bodies 10, and the wire springs 12 are bent and deformed as illustrated in FIG. 6.

The support plates 11 are a flat rectangular plate larger in outer shape size than the helical structure bodies 10. As illustrated in FIG. 3, the respective support plates 11 are fixed in positions at equal distances d2 from a center position P on diagonal lines on the front face 2a. Here, the respective support plates 11 are fixed so that longitudinal sides 11a oppose each other across the center position P in parallel with each other. In this manner, regarding the helical structure bodies 10 opposing each other across the center position P, the center axes CL of the wire springs 12 oppose each other in parallel. Arranging directions for the wire springs 12 are set in two ways. Further, by fixing the support plates 11 in the above-described positions, the helical structure bodies 10 are disposed at equal intervals on the base member 2.

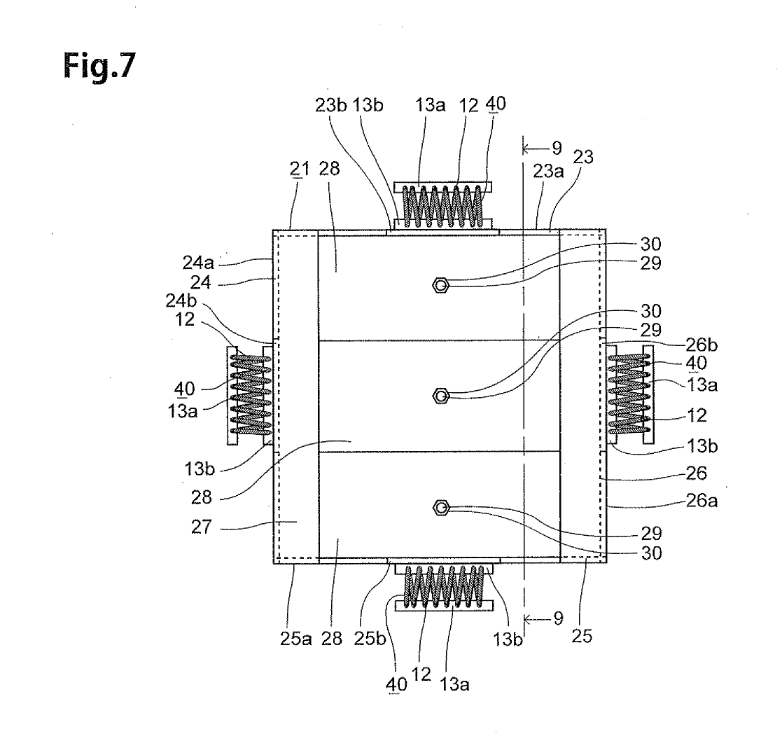

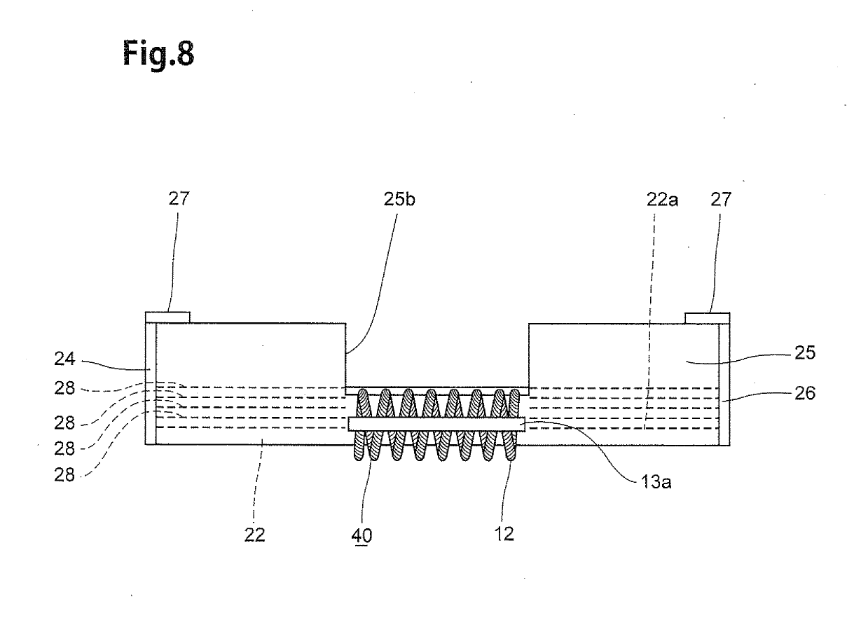

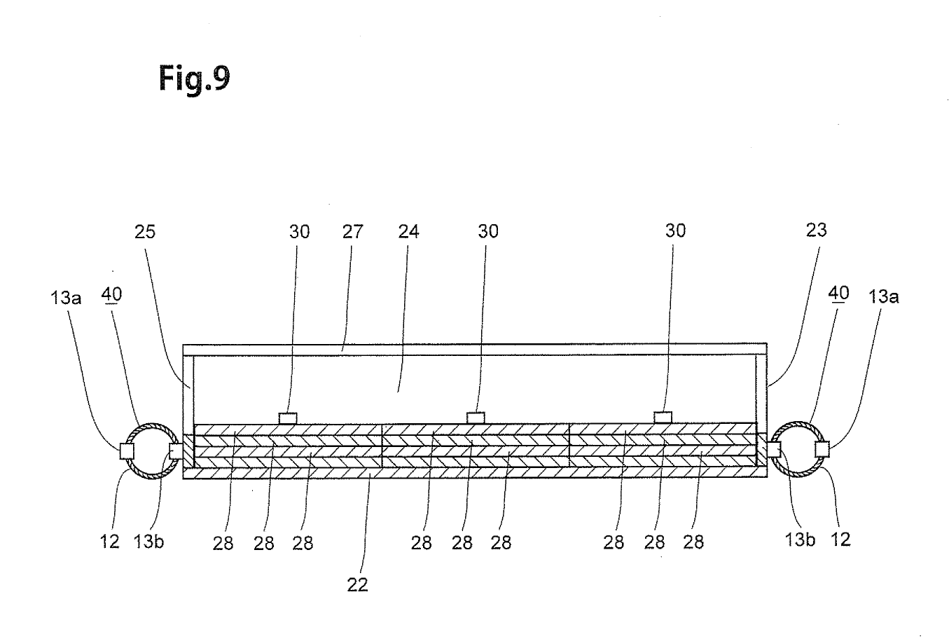

Next, the upper unit 21 will be described. The upper unit 21 has a base member 22, four wall members 23, 24, 25, 26, four helical structure bodies 40, two receiving plates 27, a plurality (twelve in FIG. 8 and FIG. 9) of weights 28, bolts 29, and nuts 30, as illustrated in FIG. 1, FIG. 2, and FIG. 7 to FIG. 9.

The base member 22 is a plate formed in a square shape using metal such as steel similarly to the base member 2, and has a flat front face 22a and a flat rear face 22b. This base member 22 is a second base member in the present invention and is formed to be smaller in outer shape size than the base member 2. Further, the bolts 29 are fixed on the front face of the base member 22 so that the bolts 29 stand up.

The wall members 23, 24, 25, 26 are second wall members in the present invention, and are plates formed using metal such as steel similarly to the base member 22. The wall members 23, 24, 25, 26 have equal heights and thicknesses, and are fixed to a circumferential edge portion of the base member 22 so that respective front faces 23a, 24a, 25a, 26a orthogonally intersect the front face 2a. These wall members 23, 24, 25, 26 and the base member 22 form a space for housing the weights 28. Further, in the wall members 23, 24, 25, 26, rectangular cutout portions 23b, 24b, 25b, 26b are formed in respective substantially middle portions in a width direction, as illustrated in detail in FIG. 8.

In addition, the upper unit 21 according to this embodiment has a structure such that the wall members 23, 24, 25, 26 are fixed to the base member 22. In the upper unit 21, the base member 22 and the wall members 23, 24, 25, 26 are separate members. However, the upper unit 21 may have a box-like structure in which the wall members 23, 24, 25, 26 are formed on the circumferential edge portion of the base member 22 and hence both of them are integrated. In this case, this box-like structure is the base member.

The helical structure bodies 40 each have a wire spring 12 and rod members 13a, 13b, and have a constitution similar to the helical structure body 10 described above. The wire spring 12 of each helical structure 40 constitutes a second looped rope member in the present invention.

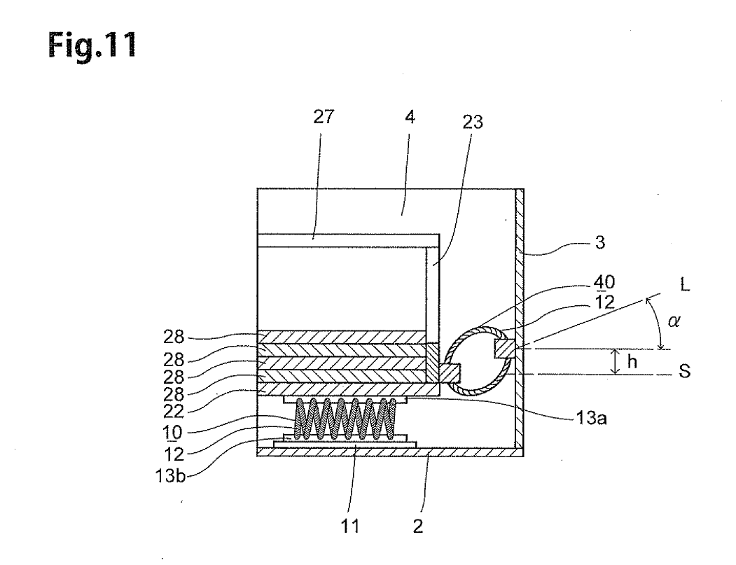

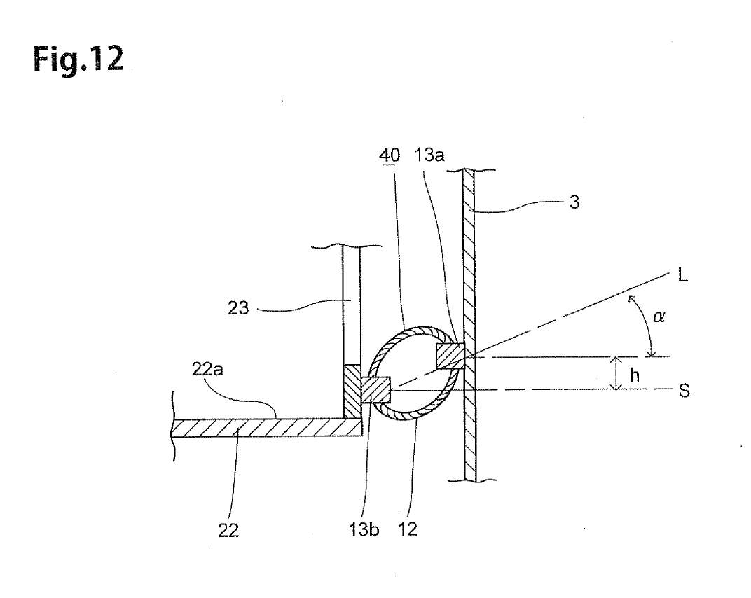

In each helical structure body 40, the rod member 13b is fixed to a lower portion of one of the respective cutout portions 23b, 24b, 25b, 26b of the wall members 23, 24, 25, 26. The respective helical structure bodies 40 are fixed to the wall members 23, 24, 25, 26 with the loop portions 12a standing up, and are disposed at equal intervals. In addition, the respective helical structure bodies 40 are disposed in four directions of front, rear, left, and right directions of the weights 28. Since the respective rod members 13a are fixed to the wall members 3, 4, 5, 6 described above, the respective helical structure bodies 40 are fixed to the wall members 3, 4, 5, 6 also with the loop portions 12a standing up (see FIG. 11 and FIG. 12 described later for details).

The receiving plates 27 are rectangular metal plates, one being fixed to upper end portions of the wall members 23, 24, 25, and the other being fixed to upper end portions of the wall members 25, 26, 23. A not-illustrated lid member is fixed to these two receiving plates 27.

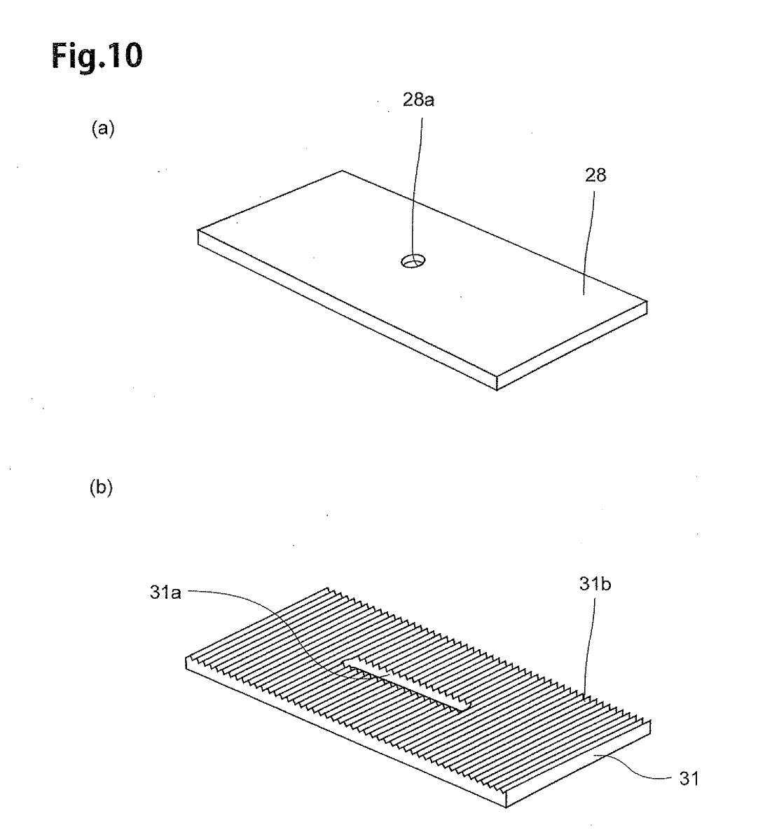

The weights 28 are rectangular plates formed to have the size of substantially ⅓ of the base member 22 using metal such as steel, as illustrated in FIG. 10 (a). In each weight 28, an insertion hole 28a for inserting the bolt 29 is formed in the center. In the upper unit 21, three sets of four stacked same weights 28 are fixed on the base member 22. Therefore, twelve weights 28 in total are fixed on the base member 22 in the upper unit 21. When fixing them, each weight 28 is fixed on the base member 22 by mounting on the base member 22 and inserting of the bolt 29 through the insertion hole 28a, and then fastening the nut 30 onto the bolt 29. Each weight 28 is structured to be attachable to and detachable from the base member 22 by fastening or releasing the nut 30.

In the upper unit 21, a weight 31 illustrated in FIG. 10 (b) may be used instead of each weight 28. In this weight 31, depression and projection portions 31b in a saw-tooth shape is formed in each of its front face and rear face (the rear face is not illustrated). Further, an insertion hole 31a is a long hole (also called a loose hole) which is long in a longitudinal direction.

When the weights 31 are stacked, respective depression and projection portions 31b become bite each other. Accordingly, when a vibration is applied to the vibration damping apparatus 50, the projection and recess portions 31b of the respective weights 31 hit against each other. This prevents the weights 31 from sliding (lateral sliding). Therefore, using the weights 31, a vibration suppressing effect of the vibration damping apparatus 50 can be enhanced. Further, the insertion hole 31a allows sliding easily in the longitudinal direction because it is a long hole in the longitudinal direction. Accordingly, the weights 31 easily slide and collide with the wall members 23, 24, 25, 26, and thereby the vibration suppressing effect of the vibration damping apparatus 50 can be further enhanced.

The vibration damping apparatus 50 has a constitution such that the upper unit 21 is housed in the lower unit 1 having the constitution as described above from an upper side, as illustrated in FIG. 1. In this case, the upper unit 21 can be housed in the space 17 from the upper side since the outer shape size of the base member 22 of the upper unit 21 is smaller than the base member 2 of the lower unit 1. Further, since the wall members 3, 4, 5, 6 are fixed to the circumferential edge portion of the base member 2, and the wall members 23, 24, 25, 26 are fixed to the circumferential edge portion of the base member 22, a gap can be made between the wall members 3, 4, 5, 6 and the wall members 23, 24, 25, 26. The width of this gap is adapted to the distance between the rod member 13a and the rod member 13b, and thus the helical structure bodies 40 are fixed to both the wall members 23, 24, 25, 26 and the wall members 3, 4, 5, 6.

Further, when the upper unit 21 is housed in the lower unit 1, the base member 22 opposes the base member 2. Here, since the helical structure bodies 10 are fixed to the base member 2 with the loop portions 12a standing up, the helical structure bodies 10 are fixed not only to the base member 22 but also to the base member 2.

On the other hand, since the weights 28 are fixed to the upper unit 21, when the upper unit 21 is housed in the lower unit 1, the helical structure bodies 10 are bent by the loads of the weights 28 and the base member 22. Accordingly, as illustrated in FIG. 11, more specifically in FIG. 12, the sides of the rod members 13b of the helical structure bodies 40 are displaced downward in a vertical direction to be lower than the rod members 13a by a height h. That is, the helical structure bodies 40 are fixed in a state that fixing positions on the sides of the wall members 23, 24, 25, 26 (second fixing positions in the present invention) are displaced downward to be lower than fixing positions on the sides of the wall members 3, 4, 5, 6 (first fixing positions in the present invention) (this state is referred to as inward down inclination).

Then an inclination angle α appears between a straight line L connecting the fixing positions of the helical structure bodies 40 to the wall members 3, 4, 5, 6 and the fixing positions of the helical structure bodies 40 to the wall members 23, 24, 25, 26 and a horizontal plane S (exactly the front face 22a of the base member 22). This inclination angle α is desired to be set in the range of 5 degrees to 10 degrees, from results of examples which will be described later.

Operations of the Vibration Damping Apparatus

Next, operations of the vibration damping apparatus 50 having the above-described constitution will be described. In order to be used, the vibration damping apparatus 50 is fixed to a stationary structure for which a vibration is to be damped (a wooden house is assumed as an example of the stationary structure in the following description).

For example, it is assumed that an earthquake occurs and a horizontal vibration is generated in the wooden house. Accompanying this vibration, the vibration damping apparatus 50 then vibrates in a horizontal direction together with the wooden house. However, since the vibration damping apparatus 50 has the upper unit 21 in which the weights 28 are fixed, and these weights 28 have inherent inertia, they vibrate in the horizontal direction at inherent vibration cycles. When the weights 28 vibrate in the horizontal direction, the upper unit 21 vibrate similarly.

The helical structure bodies 10 are fixed to both the base member 22 of the upper unit 21 and the base member 2 of the lower unit 1. Accordingly, relative positions of the base member 22 and the base member 2 displace in the horizontal direction accompanying the vibration of the upper unit 21. The external force that caused this displacement (positional displacement in the horizontal direction) is applied to the wire springs 12 of the helical structure bodies 10 via the rod members 13a, 13b.

At this time, the wire spring 12 has elasticity because it is formed in a helical shape, and exhibits force of restitution to return to the original shape when deformed by the external force. When the wire spring 12 is deformed, twisting of the rope member 16 occurs and may generate buckling, but generation of buckling is suppressed since the respective loop portions 12a are inserted through the rod members 13a, 13b. Further, since the wire spring 12 is fixed with the plurality of loop portions 12a standing up, the external force is applied to the all loop portions 12a. The respective loop portions 12a are deformed such as being slanted or bent according to the direction and magnitude of the applied external force, but generate force of restitution in parallel simultaneously and moves to cancel out the change of shape.

On the other hand, the wire spring 12 is constituted using the rope member 16. The rope member 16 is formed by twining a large number of linear members 14. Accordingly, when the loop portions 12a move as described above, adjacent ones of the linear members 14 rub strongly against each other and generate heat. That is, the wire spring 12 has a heat conversion function to convert applied external force into heat. The loop portions 12a are deformed according to the direction and magnitude of the applied external force and generate heat accompanying this deformation, and thereby the wire spring 12 absorbs the applied external force. Further, whatever displacements along a horizontal direction the rod members 13a, 13b make, the wire spring 12 exhibits the heat conversion function corresponding to the displacements. Therefore whatever vibrations along a horizontal direction the wooden house make (or the direction of an occurring vibration is irregular), the vibration is able to be absorbed by the helical structure bodies 10.

Further, when a vertical vibration occurs, the wire springs 12 of the helical structure bodies 10 are bent according to external force. Thus, the helical structure bodies 10 also have a vibration absorbing function in the vertical direction while they mainly have a vibration absorbing function in the horizontal direction. Moreover, the wire springs 12 have the helical structure including the plurality of loop portions 12a and thus effectively exhibit an elastic operation to restore deformation by displacement in the horizontal direction.

Since the linear members 14 have a circular cross sectional shape, numerous gaps are formed between them while adjacent ones are in contact with each other. Accordingly, the heat generated by the linear members 14 is diffused and emitted in the air without being kept inside the helical structure bodies 10.

Further, in the vibration damping apparatus 50, the base members 2, 22 are disposed in an up-and-down of the helical structure bodies 10 sandwiching it. The helical structure bodies 10 are fixed to both the base members 2, 22 with the loop portions 12a standing up. Employing such a structure, the vibration damping apparatus 50 is able to securely exhibit the heat conversion function by the loop portions 12a of the wire springs 12 with respect to a horizontal vibration. Moreover, the vibration damping apparatus 50 has four helical structure bodies 10, and arrangement directions of the wire springs 12 are set in two ways. Accordingly, the way of deformation of the wire springs 12 is diversified, and various vibrations along the horizontal direction is able to be suppressed effectively.

On the other hand, let us assumed that an inland earthquake occurs and a vertical vibration is generated in the above-described wooden house. Then the vibration damping apparatus 50 vibrates in a vertical direction together with the wooden house accompanying this vibration. The vibration damping apparatus 50 vibrates in a vertical direction (upward and downward) at inherent vibration cycles of the weights 28. When the weights 28 vibrate in the vertical direction, the upper unit 21 vibrates similarly.

The helical structure bodies 40 are fixed to both the wall members 23, 24, 25, 26 of the upper unit 21 and the wall members 3, 4, 5, 6 of the lower unit 1. Thus, relative positions of the wall members 23, 24, 25, 26 and the wall members 3, 4, 5, 6 are displaced in a vertical direction accompanying the vibration of the upper unit 21. The external force that caused this displacement (positional displacement in the vertical direction) is applied to the wire springs of the helical structure bodies 40 via the rod members 13a, 13b. This external force is applied to the respective loop portions 12a in their entireties. Also in this case, the respective loop portions 12a are deformed by, for example, changing the standing state according to the direction and magnitude of the applied external force, but generate force of restitution in parallel at the same time and move to cancel out the change of shape. Since the wire springs 12 have the above-described heat conversion function, the helical structure bodies 40 exhibit a heat conversion function similar to that when a horizontal vibration occurs, so as to absorb the vertical vibration.

In the vibration damping apparatus 50, the helical structure bodies 40 are fixed to the wall members 3, 4, 5, 6 and the wall members 23, 24, 25, 26 with the loop portions 12a standing up. By employing such a structure, the vibration damping apparatus 50 is able to reliably exhibit the heat conversion function by the loop portions 12a of the wire spring 12 with respect to the vertical vibration.

Moreover, the vibration damping apparatus 50 has four helical structure bodies 40, and they are disposed at equal intervals. Accordingly, external force by a vertical vibration would not concentrate in one of them and is absorbed by the four helical structure bodies 40 in a balanced manner. Thus, the vibration damping apparatus 50 is able to suppress a vertical vibration in a balanced manner by the four helical structure bodies 40.

Further, when a horizontal vibration occurs, the wire springs 12 of the helical structure bodies 40 are bent according to external force. Thus, the helical structure bodies 40 also have a vibration absorbing function in the horizontal direction while they mainly have a vibration absorbing function in the vertical direction. Moreover, since the wire springs 12 have the helical structure including the plurality of loop portions 12a, the wire springs 12 have elasticity and restore deformation by displacement in the vertical direction.

Incidentally, when a vibration due to an earthquake occurs in a wooden house, rather than that only one of horizontal vibration and vertical vibration occurs, a three-dimensional vibration combining both of them occurs more frequently. Moreover, the direction of vibration is different and irregular each time, and the direction may even change from the start of vibration until the end of vibration. A vibration generated in a stationary structure such as a wooden house or a mobile structure by an earthquake, a vibration generated in a traveling vehicle or the like, and a vibration generated in a bridge or the like accompanying traveling of a vehicle may become such an irregular three-dimensional vibration.

However, by employing the above-described constitution, the vibration damping apparatus 50 is able to exhibit the heat conversion function in response to a horizontal vibration and the heat conversion function in response to a vertical vibration by the wire springs 12 in parallel simultaneously. When the irregular three-dimensional vibration occurs in the structure, a horizontal direction component of the vibration is suppressed mainly by the helical structure bodies 10, and a vertical direction component of the vibration is suppressed mainly by the helical structure bodies 40. The helical structure bodies 10, 40 absorb vibrations by the respective wire springs 12 exhibiting the heat conversion function according to the direction and magnitude of applied external force. Accordingly, whatever three-dimensional vibrations occur, the vibration damping apparatus 50 is able to suppress those vibrations. Therefore, the vibration damping apparatus 50 has a significantly enlarged range of vibrations to be suppressed as compared to conventional arts, and is capable of sufficiently suppressing the irregular three-dimensional vibration.

Further, the vibration damping apparatus 50 is able to be installed in a structure by fixing the base member 2 to a floor or the like of a wooden house. Thus, the vibration damping apparatus 50 is able to be installed not only in a house under construction but also in an existing house which is already built.

Furthermore, the vibration suppressing effect of the vibration damping apparatus 50 is enhanced by setting the inclination angle α in the range of 5 degrees to 10 degrees. Moreover, since the vibration damping apparatus 50 has the plurality of weights 28 which are structured attachably and detachably, the weight of the upper unit 21 is able to be adjusted by changing the weight of the weights 28 to be fixed depending on the structure in which the apparatus is installed. Since the weights 28 have the same size and the same weight, the weight of the upper unit 21 is able to be adjusted quantitatively. Moreover, cutout portions 23a, 24a, 25a, 26a are formed in the wall members 23, 24, 25, 26, and thus taking the weights 28 in and out of the upper unit 21 can be performed easily. Also by forming the cutout portions 23a, 24a, 25a, 26a only in at least one of the wall members 23, 24, 25, 26, taking the weights 28 in and out can be performed easily. However, when the cutout portions 23a, 24a, 25a, 26a are formed in all of the wall members 23, 24, 25, 26, the weights 28 can be taken in and out easily from any direction, which makes it more preferable.

### Modified Example 1

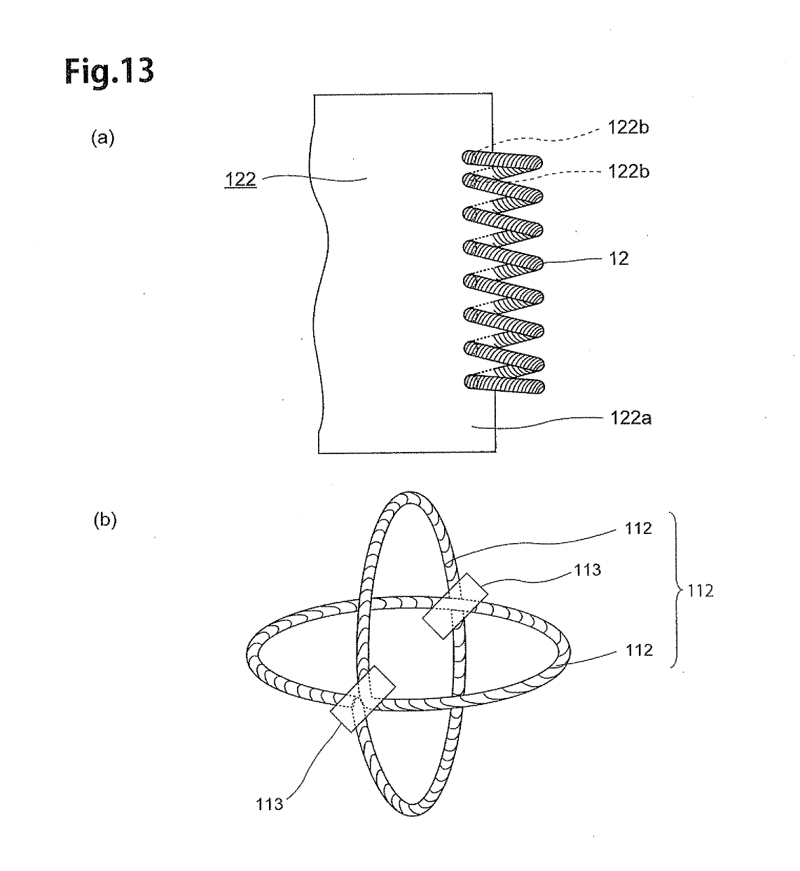

Next, a modified example of the vibration damping apparatus 50 will be described referring to FIG. 13. FIG. 13 (a) is a plan view illustrating a base member 122 and a wire spring 12 according to the modified example, which are partially omitted. FIG. 13(b) is a perspective view illustrating a wire spring 112 according to the modified example.

While the helical structure bodies 40 are fixed to the wall members 23, 24, 25, 26 in the above-described vibration damping apparatus 50, the wire springs 12 may be fixed to a circumferential edge portion 122a of the base member 122 so that the loop portions 12a extend out from the circumferential edge portion 122a and stand up as illustrated in FIG. 13 (a). The base member 122 is a plate similar to the base member 22, but a plurality of through holes 122b corresponding to the loop portions 12a are formed in the circumferential edge portion 122a. By inserting the loop portions 12a through the respective through holes 122b, only one of two opposing portions engages with the base member 122. Then the wire springs 12 are fixed to the base member 122 with portions other than the engaged opposing portions extending out from the base member 122 and standing up. When the wire springs 12 are fixed to the wall members 3, 4, 5, 6, a predetermined range from the portion extending out farthest (that is, the other of the two opposing portions) may be fixed by welding or caulking. Also in this manner, the heat conversion function in response to the vertical vibration is able to be exhibited by the wire springs 12, and thus the vibration damping apparatus 50 is able to sufficiently suppress the irregular three-dimensional vibration.

On the other hand, the wire spring 112 has two intersecting loop portions 112a, 112b, and has a structure in which two intersecting parts of the loop portions 112a, 112b are fixed by connecting members 113. Regarding one rope member 16, the wire spring 112 is obtained by first forming an loop portion 112a to turn around a horizontal plane, subsequently forming an loop portion 112b to turn around a vertical plane, and then fixing both ends of the rope member 16 and the two intersecting parts of the loop portions 112a, 112b by the connecting members 113.

The wire spring 112 is able to be sandwiched between the base members 2, 22 and fixed to both the base members instead of the helical structure bodies 10. Further, the wire spring 112 can be sandwiched between the wall members 3, 4, 5, 6 and the wall members 23, 24, 25, 26 and fixed to both the wall members instead of the helical structure bodies 40.

When a vibration occurs in the thus obtained vibration damping apparatus 50, external force that caused positional displacement accompanying the vibration is applied to the wire spring 112. Similarly to the wire spring 12, the wire spring 112 exhibits the heat conversion function corresponding to the direction and magnitude of the applied external force to absorb the external force. Accordingly, the vibration damping apparatus 50 is capable of sufficiently suppressing the irregular three-dimensional vibration even using the wire spring 122 instead of the wire spring 12.

### Modified Example 2

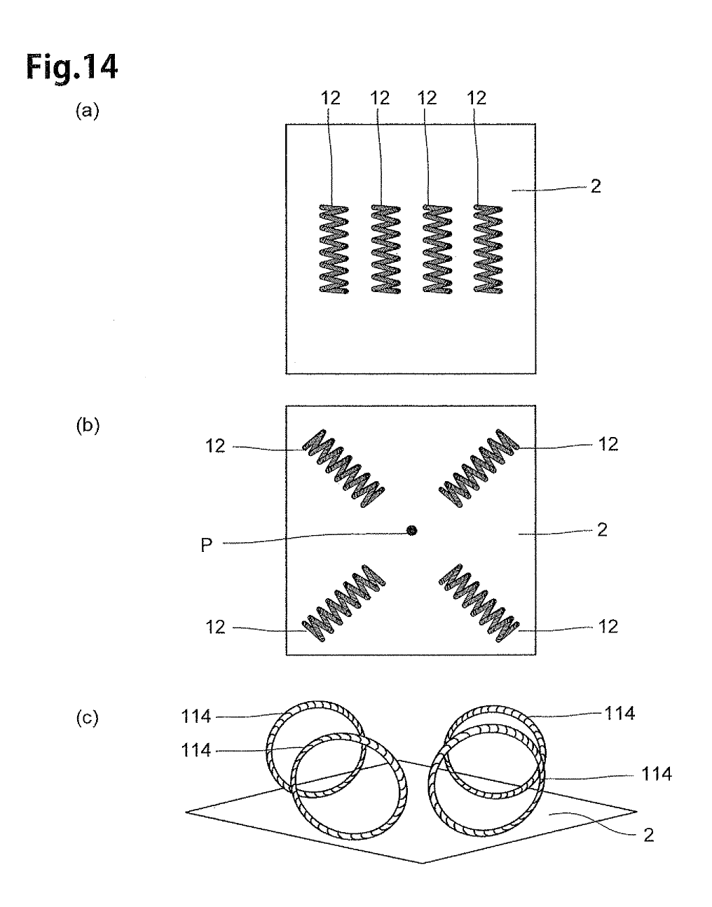

Next, another modified example of the vibration damping apparatus 50 will be described referring to FIG. 14. FIG. 14 (a) is a plan view illustrating a state that four wire springs 12 are fixed to the base member 2. FIG. 14 (b) is a plan view illustrating a state that the four wire springs are fixed in a different arrangement. FIG. 14 (c) is a perspective view illustrating the base member 2 on which four wire rings 114 are fixed.

In the above-described vibration damping apparatus 50, the helical structure bodies 10 are fixed in the arrangement illustrated in FIG. 3. However, as illustrated in FIG. 14 (a), the four wire springs 12 may be fixed to the base member 2 at equal intervals. Further, as illustrated in FIG. 14 (b), the four wire springs 12 may be arranged at equal distances from the center p on diagonal lines.

Moreover, both ends of the rope member 16 may be connected to make a wire ring 114 of one winding, and this wire ring 114 may be fixed to stand up along the circumferential edge portion of the base member 2. By employing any one of them, the vibration damping apparatus 50 is capable of sufficiently suppressing the irregular three-dimensional vibration.

### Example

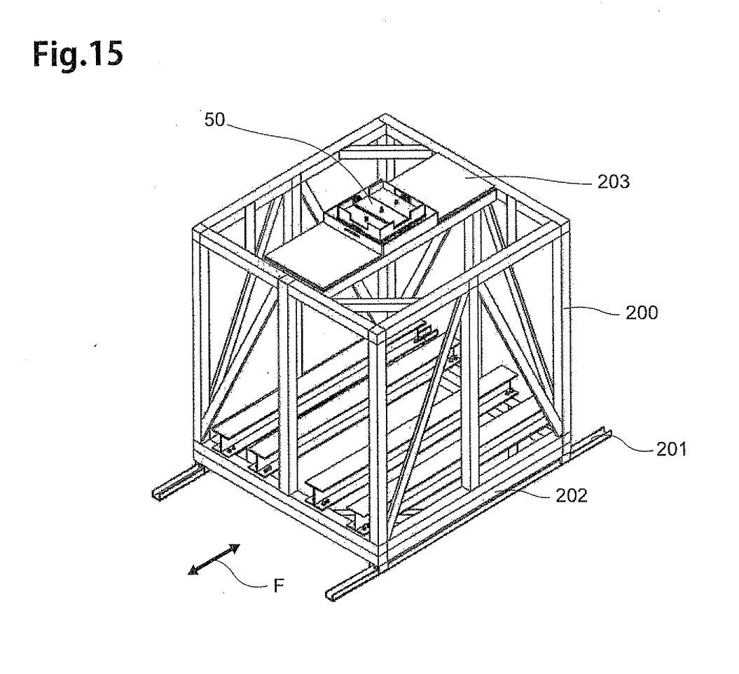

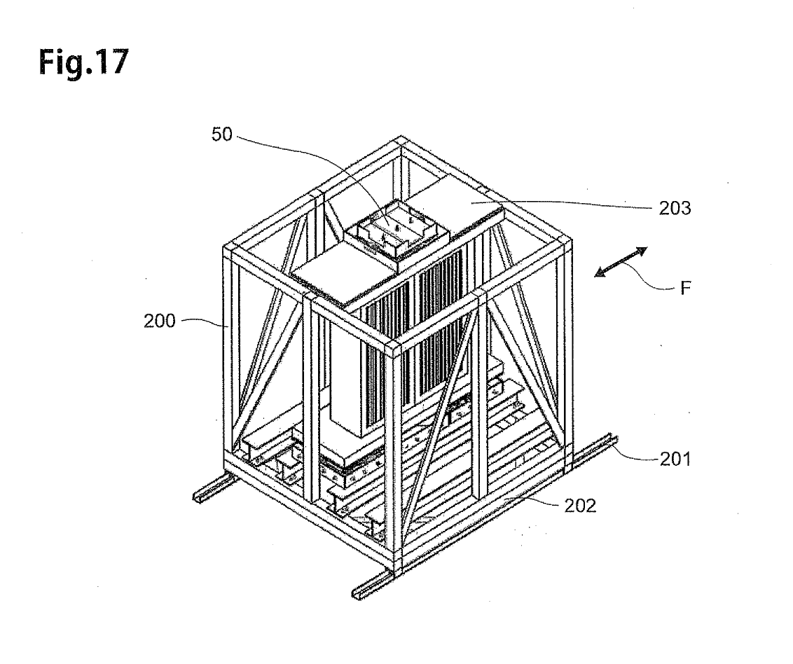

Next, an example of the above-described vibration damping apparatus 50 will be described referring to FIG. 15 to FIG. 20. In this example, a trial model of the above-described vibration damping apparatus 50 was made, and a wooden building frame 200 as illustrated in FIG. 15, FIG. 17, and so on is built. The wooden building frame 200 is structured to slide integrally with a vibration table 202 on guide rails 201 in a horizontal direction denoted by an arrow F. A weight 203 is placed on an upper face (the second floor of a wooden house) of this wooden building frame 200, and the above-described vibration damping apparatus 50 is fixed thereon.

The built wooden building frame 200 has a height of about 2.5 m, a width of about 2.2 m, and a depth of about 2.4 m, and weighs about 1 t. The vibration table 202 is not capable of restricting up and down movement, and is structured to slide on the guide rails 201. Thus, when pulling force is generated, it is possible to reproduce lifting up of the wooden building frame 200.

For comparison, besides the case of fixing the above-described vibration damping apparatus 50, there was prepared an apparatus obtained by removing the helical structure bodies 40 from the vibration damping apparatus 50 (apparatus for comparison, which is not illustrated), and this apparatus for comparison was fixed to the wooden building frame 200 instead of the vibration damping apparatus 50.

For both of the wooden building frame 200 to which the vibration damping apparatus 50 is fixed and the wooden building frame 200 to which the apparatus for comparison is fixed, a kinetic energy damping ratio was measured in each of a vertical direction and a horizontal direction. This damping ratio was obtained from comparison with kinetic energy of only the wooden building frame 200, which was measured in advance.

In the wooden building frame 200 to which the apparatus for comparison is fixed, the damping ratio was low in its entirety. Meanwhile, in the wooden building frame 200 to which the vibration damping apparatus 50 is fixed, it was confirmed that the damping ratio is highly improved. Specifically, the damping ratio in the vertical direction was about 10% to 30% in the former wooden building frame 200, whereas the damping ratio in the vertical direction was about 30% to 70% in the latter wooden building frame 200. Further, the damping ratio in the horizontal direction was about 5% to 25% in the former wooden building frame 200, whereas the damping ratio in the horizontal direction was about 10% to 55% in the latter wooden building frame 200. From these results, it is able to be understood that the vibration suppressing effect is improved in both the horizontal direction and the vertical direction by employing the vibration damping apparatus 50.

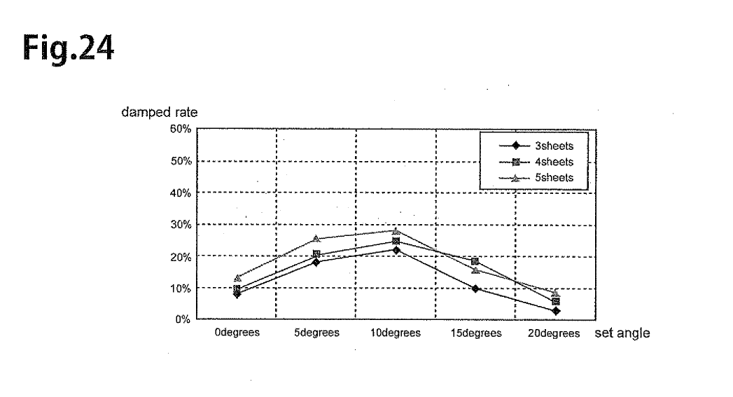

Further, the damping ratios were measured while appropriately changing the number of weights 28 of the vibration damping apparatus 50 and the above-described inclination angle α. Results of the measurement are illustrated in FIG. 24. As is clear from FIG. 24, whatever the mounting numbers of weights 28 are, the damping ratios when the inclination angle α becomes 5 degrees or 10 degrees are higher than any other cases. Accordingly, it is able to be assumed that the inclination angle α is effective when being set in the range of 5 degrees to 10 degrees.

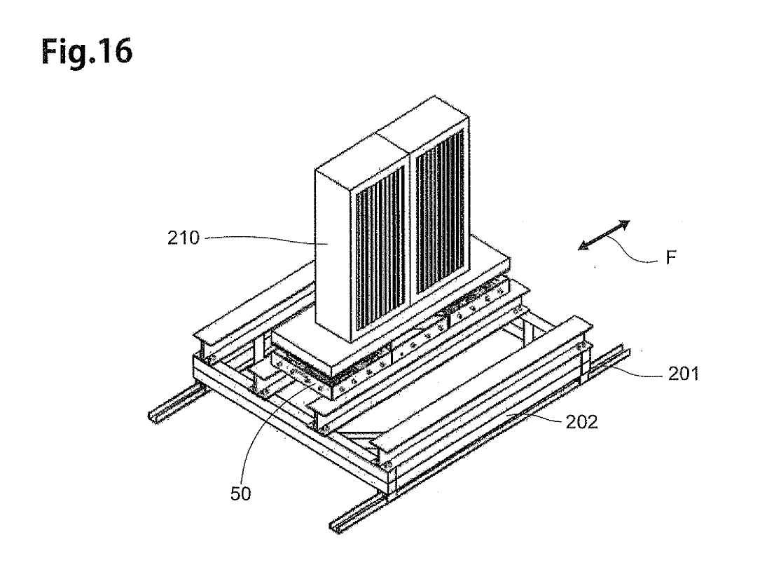

FIG. 16 is a perspective view illustrating three vibration damping apparatuses 50 aligned and fixed on the vibration table 202, a lid member 204 placed thereon, and a stationary structure 210 placed thereon. For example, the stationary structure 210 is assumed to be a precision machine such as a computer, an industrial machine, or the like, and is assumed to be a server in FIG. 16. It was confirmed that the vibration suppressing effect is improved in both the horizontal direction and the vertical direction, similarly to the above-described example, also when the experiment is performed in this manner.

In FIG. 16, a vibration inputted from the vibration table 202 is suppressed by the vibration damping apparatus 50 and then inputted to the stationary structure 210. In the stationary structure 210 of this type, particularly protection from vibrations is highly important. Accordingly, by installing the vibration damping apparatus 50 in an intervening manner as illustrated in FIG. 16, the vibration inputted to the stationary structure 210 is able to be suppressed. For example, the stationary structure 210 is able to be protected from a vibration due to an earthquake, strong wind, or the like or a vibration generated during transportation by a vehicle.

Further, FIG. 17 is a perspective view illustrating three vibration damping apparatuses 50 aligned and fixed on the vibration table 202 in the wooden building frame 200 illustrated in FIG. 15, a lid member 204 placed thereon, and a stationary structure 210 placed thereon. Also in this case, it was confirmed that the vibration suppressing effect is improved in both the horizontal direction and the vertical direction, similarly to the above-described examples.

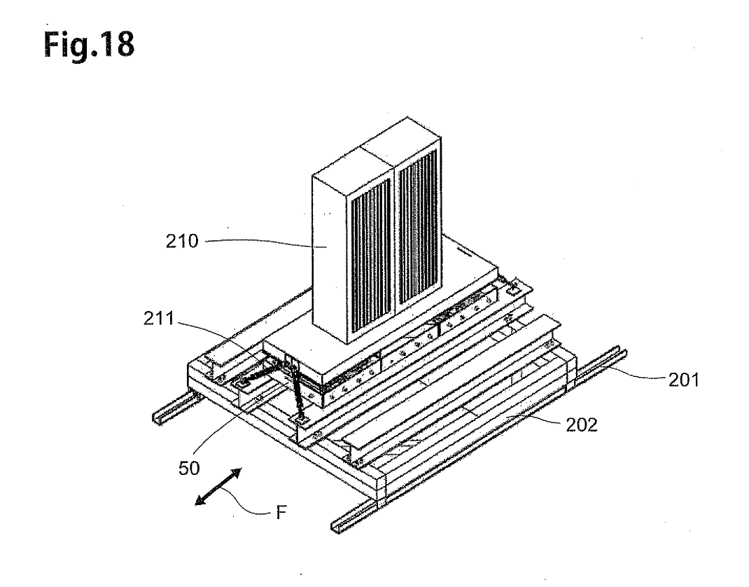

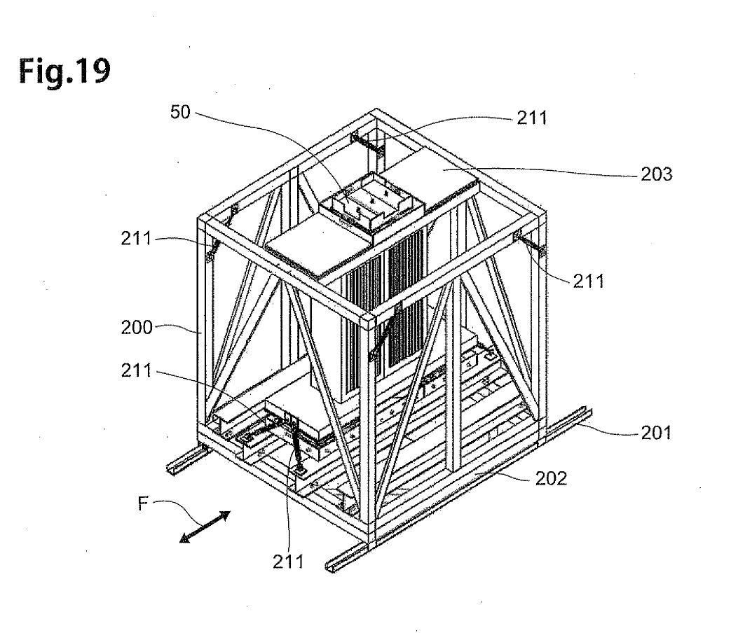

On the other hand, for example a vibration due to an earthquake is inputted to a stationary structure such as a wooden house, it is possible that, at an early time when the vibration is started, there is inputted a vibration larger than a vibration thereafter. For effectively suppressing a particularly large vibration inputted initially, it is desired that dampers 211 be provided along a portion particularly where reinforcement is needed structurally, as illustrated in FIG. 18 and FIG. 19. In FIG. 18, the dampers 211 are attached so as to connect the lid member 204 and the vibration table 202 in the case illustrated in FIG. 16. In FIG. 19, the dampers 211 are attached where pillars and beams of the wooden building frame 200 are connected.

### Second Embodiment

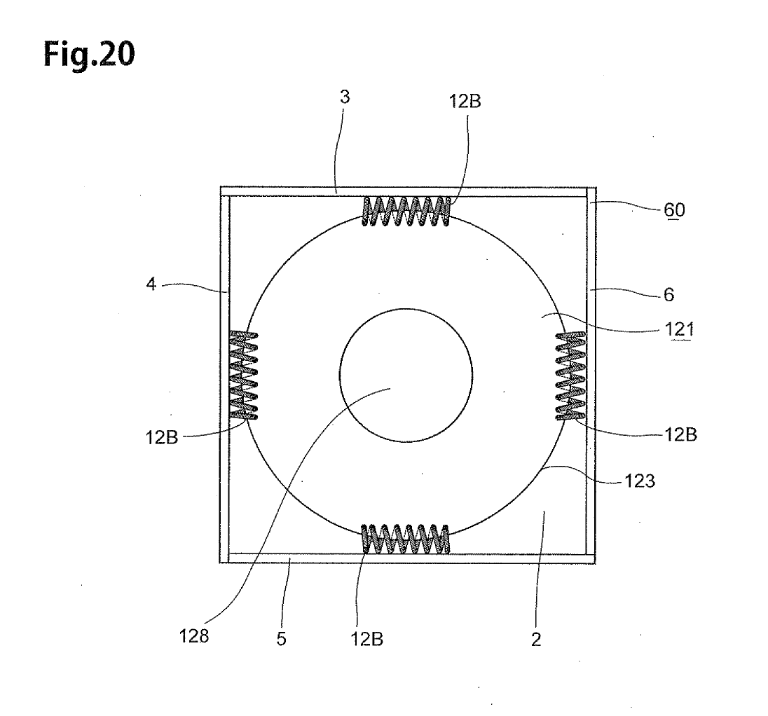

Next, the constitution of the vibration damping apparatus 60 according to a second embodiment of the present invention will be described with reference to FIG. 20. FIG. 20 is a plan view illustrating a constitution of the vibration damping apparatus 60 with a part thereof omitted. Compared to the vibration damping apparatus 50, the vibration damping apparatus 60 is different in that the upper unit 21 is changed to an upper unit 121, and that the arrangement of the four helical structure bodies 10 is changed.

The upper unit 121 has a base member 123 having a disc shape, and four wire springs 12B are arranged and fixed at equal intervals on a circumferential edge portion of the base member 123 along a circumferential direction with loop portions extending out and standing up. The wire springs 12B each have a plurality of loop portions 12a similarly to the wire springs 12. Further, the wire springs 12B are fixed to the wall members 3, 4, 5, 6. Weights 128 having a disc shape are mounted on the base member 123. The arrangement of the four helical structure bodies 10 is changed accompanying that the base member 123 has a disc shape (the four helical structure bodies 10 are disposed on a lower side of the base member 123, and thus are not illustrated in FIG. 20).

Also in the vibration damping apparatus 60 having such a constitution, a vibration in a horizontal direction is suppressed mainly by the wire springs 12 of the helical structure bodies 10, and a vibration in the vertical direction is suppressed mainly by the wire springs 12B. Accordingly, the vibration damping apparatus 60 is capable of sufficiently suppressing the irregular three-dimensional vibration, similarly to the vibration damping apparatus 50.

### Third Embodiment

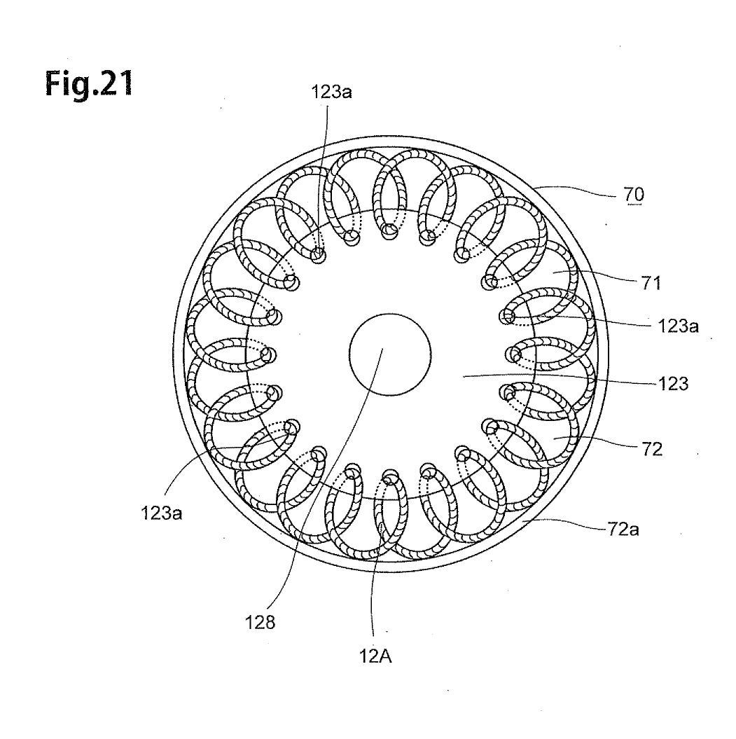

Next, the constitution of the vibration damping apparatus 70 according to a third embodiment of the present invention will be described with reference to FIG. 21. FIG. 21 is a plan view illustrating a constitution of the vibration damping apparatus 70 with a part thereof omitted. Compared to the vibration damping apparatus 60, the vibration damping apparatus 70 is different in that the lower unit 1 is changed to a lower unit 71, and that a wire spring 12A longer in length than the wire springs 12B is fixed across the entire circumference of the base member 123. The lower unit 71 has a base member 72 having a disc shape that is larger in size than the base member 123, and a cylindrical wall member 72a is formed on a circumferential edge portion thereof. The base member 72 and the wall member 72a in their entireties are formed in a cylindrical shape with a bottom.

The lower unit 1 is employed in the vibration damping apparatus 60. Accordingly, in the vibration damping apparatus 60, the base member 2 has a square shape, and distances between the wall members 3, 4, 5, 6 and the base member 123 are not even. Further, it is a structure in which it is difficult to fix the wire springs 12B across the entire circumference of the base member 123.

However, in the vibration damping apparatus 70, since the lower unit 71 is employed, the wire spring 12A is fixed across the entire circumference of the base member 123. Through holes 123a are formed at equal intervals across the entire circumference in the base member 123a, and the wire spring 12A is inserted therethrough. The wire spring 12A is fixed to both the base member 123 and the wall portion 72a.

The vibration damping apparatus 70 as such is capable of sufficiently suppressing the irregular three-dimensional vibration, similarly to the vibration damping apparatus 60. In addition, in the vibration damping apparatus 70, the wire spring 12A is fixed across the entire circumference of the base member 123. Accordingly, the vibration damping apparatus 70 has no unevenness in the vibration suppressing effect in the vertical direction, and can exhibit a substantially even vibration suppressing effect across the entire circumference of the base member 123. When a horizontal vibration occurs, this vibration is suppressed mainly by the not-illustrated four helical structure bodies 10. However, when relative positions of the base member 123 and the base member 72 are displaced according to a horizontal vibration, the wire spring 12A is bent corresponding to this displacement, and thus also the wire spring 12A absorbs the horizontal vibration. In this case, since the wire spring 12A is fixed to the entire circumference of the base member 123 having a disc shape, whatever displacements along a horizontal direction the base member 123 make, the wire spring 12A is bent similarly, thereby exhibiting a substantially even vibration suppressing effect. Further, since the vibration damping apparatus 70 is longer in length of the wire spring 12A than the vibration damping apparatus 60, the vibration suppressing effect is able to be improved more than in the vibration damping apparatus 60.

### Fourth Embodiment

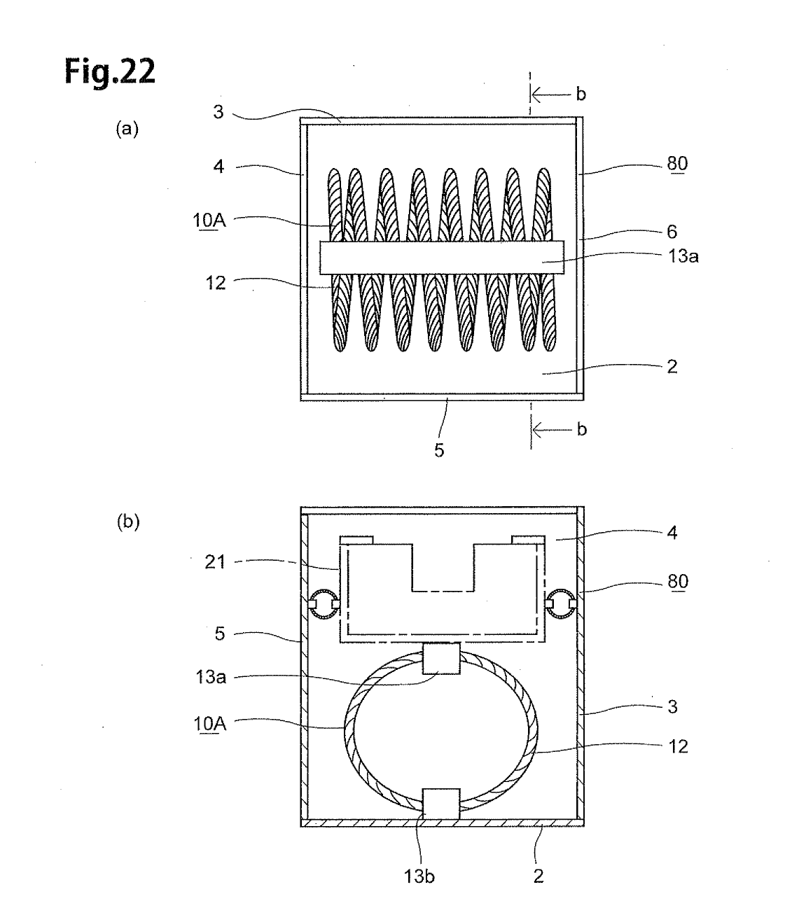

Next, the constitution of the vibration damping apparatus 80 according to a fourth embodiment of the present invention will be described with reference to FIG. 22. FIG. 22 (a) is a plan view illustrating a constitution of the vibration damping apparatus 80 with a part thereof omitted, FIG. 22 (b) is a sectional view taken along the line b-b of the vibration damping apparatus 80.

Compared to the vibration damping apparatus 50, the vibration damping apparatus 80 is different in that it has a helical structure body 10A instead of the four helical structure bodies 10 in the lower unit 1, and that the heights of the wall members 3, 4, 5, 6 are higher.

The vibration damping apparatus 50 has the four helical structure bodies 10, whereas the vibration damping apparatus 80 has one helical structure body 10A with loop portions larger in size (diameter) than those of the helical structure bodies 10. Since the helical structure body 10A is larger in size than the helical structure bodies 10, the one helical structure body 10A is fixed at the center of the base member 2. Having the four helical structure bodies 10, the vibration damping apparatus 50 is able to absorb a vibration by distributing it to the respective helical structure bodies 10. Meanwhile, although there is only one helical structure body 10A, the vibration damping apparatus 80 can suppress the irregular three-dimensional vibration sufficiently because it has a plurality of loop portions larger in size than those of the helical structure body 10.

### Modified Example

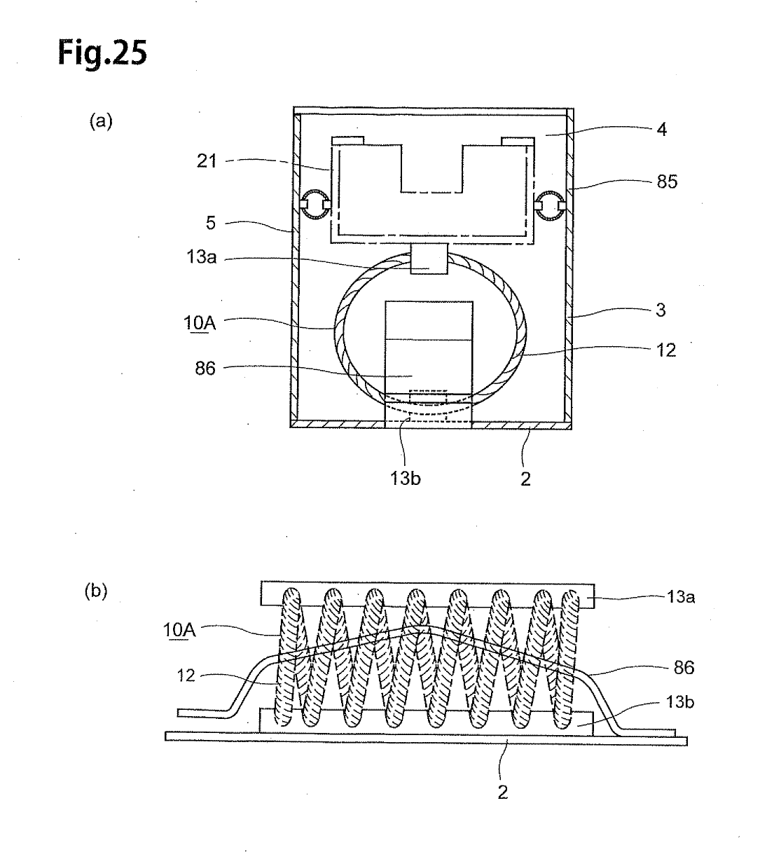

The above mentioned vibration damping apparatus 80 has one helical structure body 10A. It is possible that the helical structure body 10A is bent too much by the weight of the upper unit 21 when the upper unit 21 becomes heavy. In this case, it is preferred to have the vibration damping apparatus 85 illustrated in FIG. 25 (a), (b) instead of the vibration damping apparatus 80. The vibration damping apparatus 85 is different in that it has a plate spring 86, compared to the vibration damping apparatus 80. The plate spring 86 is disposed such that its middle portion excluding both side portions in a longitudinal direction is inserted through the inside of the loop portions 12a. The plate spring 86 is formed by, for example, appropriately bending or curving a band-shaped plate which is long in a direction along the center axis of the wire spring 12. One (one end portion) of the both end portions of the plate spring 86 is fixed to the front face of the base member 2, and the other (other end portion) is a free end suitably separated and disposed from the front face of the base member 2.

When the upper unit 21 moves downward by its weight, the rod member 13a comes in contact with the plate spring 86 when it has moved a certain distance, and deforms the plate spring 86 when it moves further. Here, the other end portion that is the free end of the plate spring 86 slides in a horizontal direction along the surface of the base member 2, and thereby the plate spring 86 exhibits force of restitution to return to its original shape. Then the plate spring 86 pushes up the rod member 13a. Thus, in the vibration damping apparatus 85, it is possible to prevent the helical structure body 10A from being bent too much.

### Fifth Embodiment

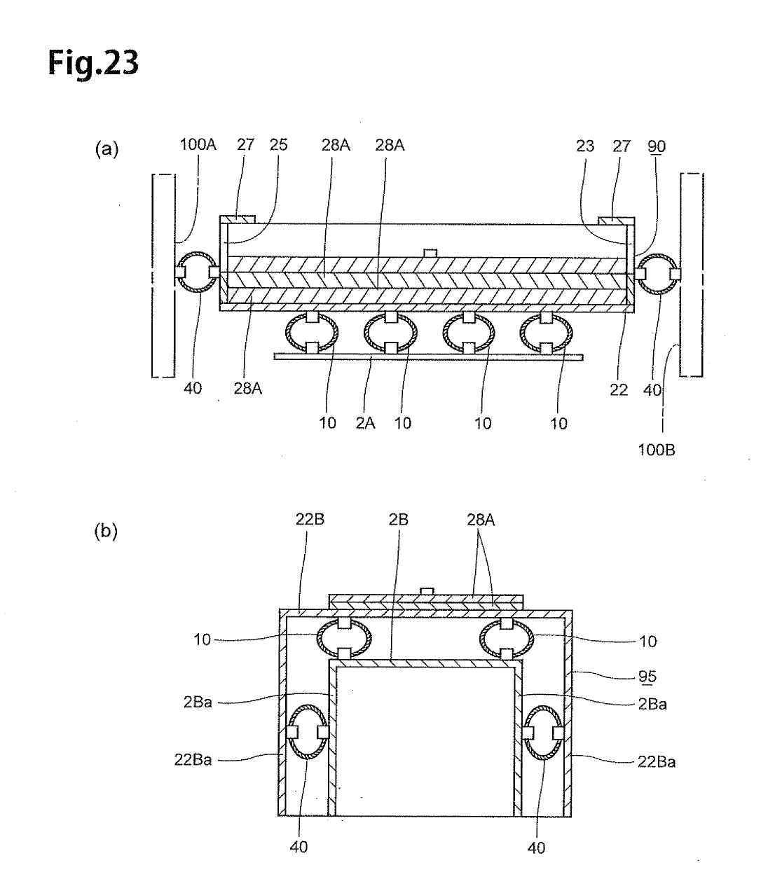

Next, the constitution of the vibration damping apparatus 90, 95 according to a fifth embodiment of the present invention will be described with reference to FIG. 23. FIG. 23 (a) is a sectional view illustrating a constitution of the vibration damping apparatus 90 with a part thereof omitted, FIG. 23 (b) is a sectional view illustrating a constitution of the vibration damping apparatus 95 with a part thereof omitted.

Compared to the vibration damping apparatus 50, the vibration damping apparatus 90 is different in that the lower unit 1 has a different structure. The vibration damping apparatus 90 has a base member 2A. The base member 2A is a square plate smaller in size than the base member 22, and formed in a flat plate shape in which the wall members 3, 4, 5, 6 are not formed. Further, compared to the vibration damping apparatus 50, the vibration damping apparatus 90 is also different in arrangement of the four helical structure bodies 10. In the vibration damping apparatus 90, the four helical structure bodies 10 are arranged in parallel at equal intervals in a width direction of the base member 2A.

In the vibration damping apparatus 50, since the wall members 3, 4, 5, 6 are formed, the helical structure bodies 40 are fixed to the wall members 3, 4, 5, 6 and the wall members 23, 24, 25, 26. The vibration damping apparatus 90 has the base member 2A instead of the base member 2. The base member 2A is a square plate smaller in size than the base member 22 and does not have the wall members 3, 4, 5, 6. The helical structure bodies 40 are not fixed to the wall members 3, 4, 5, 6, and their outsides are free ends. Inside of the helical structure bodies 40 is fixed to the wall members 23, 24, 25, 26, and outsides of the helical structure bodies 40 is fixed to structures 100A, 100B. The structures 100A, 100B are, for example, a pillar, a wall, or the like of a wooden house. Also in this manner, external force that displaces relative positions of the base member 2A and the base member 22 is absorbed by the helical structure bodies 40, and thus the vibration damping apparatus 90 is able to suppress the irregular three-dimensional vibration sufficiently, similarly to the vibration damping apparatus 50.

Next, the vibration damping apparatus 95 will be described. The vibration damping apparatus 95 has a base member 2B and a base member 22B which are disposed in an up-and-down, and helical structure bodies 10 and helical structure bodies 40 are fixed in a posture of being sandwiched between the base members 2B and the base members 22B.

The base member 2B is such that wall members 2Ba orthogonal to the plate portion are formed on a circumferential edge portion of a flat square plate portion. The base member 22B is such that wall members 22Ba orthogonal to the plate portion are formed on a circumferential edge portion of a flat square plate portion. The base member 2B is placed so that the plate portion is located higher than the wall members 2Ba. Also the base member 22B is placed so that the plate portion is located higher than the wall members 22Ba. The base member 2B and the base member 22B are disposed so that the base member 22B covers the base member 2B from the outside. Weights 28A are fixed attachably and, detachably on an upper side of the base member 22B.

When a horizontal vibration occurs in the vibration damping apparatus 95 as such, this vibration is suppressed mainly by the helical structure bodies 10. Further, when a vertical vibration is generated, this vibration is suppressed mainly by the helical structure bodies 40. Accordingly, the vibration damping apparatus 95 is able to sufficiently suppress the irregular three-dimensional vibration, similarly to the vibration damping apparatus 50. Particularly, in the vibration damping apparatus 95, since the weights 28A are fixed attachably and detachably on the upper side of the base member 22B, replacement, addition, or the like can be performed more easily than for the vibration damping apparatus 50.

In the above-described embodiments, the helical structure bodies 40 are fixed to both the wall members 3, 4, 5, 6 and the wall members 23, 24, 25, 26. However, by making the base member 22 smaller in size for example, the helical structure bodies 40 may be structured to be fixed only to the outside wall members 3, 4, 5, 6, not to the inside wall members 23, 24, 25, 26. Thus, gaps can be obtained between the helical structure bodies 40 and the inside wall members 23, 24, 25, 26. When a large displacement occurs in a structure such as a wooden house, and the upper unit 21 is displaced largely accompanying this displacement, these gaps are able to function as a buffer zone to allow the upper unit 21 to collide with the helical structure bodies 40. When the upper unit 21 moves in the buffer zone and collides with the helical structure bodies 40, kinetic energy can be absorbed, and thus the vibration can be absorbed more effectively.

On the other hand, in the embodiments, the weights 28 are provided separately from the base member (for example, the base member 22) in the upper unit, and the weights 28 are fixed to the base member (for example, the base member 22). However, the base member itself has its own weight. Accordingly, for example, by changing the thickness of the base member 22 to make it heavier, it is possible to provide the base member 22 with a function of the weights 28. In this case, a structure without the weights 28 can be made.

Further, by making the base member 22 larger in thickness, the areas of side faces of the base member 22 can be enlarged, and thus the helical structure bodies 40 can be fixed to the side faces of the base member 22. In this case, the upper unit 21 can be made as a structure without the wall members 23, 24, 25, 26. In this case, the side faces of the base member 22 to which the helical structure bodies 40 are fixed are intersecting portions orthogonally intersecting a rear face (a portion to which the helical structure bodies 10 are fixed, also called a fixing portion) of the base member 22, and the helical structure bodies 40 are fixed to these intersecting portions. In the structure having the wall members 23, 24, 25, 26 like the upper unit 21, the wall members 23, 24, 25, 26 orthogonally intersect the rear face of the base member 22 and thus exhibit a function as an intersecting portion.

This invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

It is clear that various embodiments and modified examples of the present invention is able to be carried out on the basis of the above explanation. Therefore, the present invention is able to be carried out in modes other than the above-mentioned best modes within the scope equivalent to the following claims.

In the above-described embodiments, a wooden house, a precision machine, an industrial machine, and the like are described mainly as the stationary structure, but the present invention is able to be applied to stationary structures and mobile structures other than those described above. The present invention is able to be applied to, for example, a stationary structure such as a bridge or an elevated road or railway, and to a mobile structure such as a vehicle, an airplane, or a ship.

What is claimed is:

1. A vibration damping apparatus, comprising:
a first looped rope member and a second looped rope member each having a loop portion formed of a rope member in a loop shape, the rope member being formed by twining a plurality of linear members; and
a first base member and a second base member disposed in an up-and-down of the first looped rope member,
wherein the first looped rope member is fixed to the first base member and the second base member with the loop portion standing up, and
wherein the second looped rope member is fixed to an intersecting portion, in one of the first base member and the second base member, intersecting a fixing portion of the first looped rope member with the loop portion standing up.

2. The vibration damping apparatus according to claim 1, further comprising:
a weight structured to be attachable to and detachable from the one of the first base member and the second base member to which the second looped rope member is fixed.

3. A vibration damping apparatus, comprising:
a first looped rope member and a second looped rope member each having an loop portion formed of a rope member in a loop shape, the rope member being formed by twining a plurality of linear members;
a first base member disposed on a lower side of the first looped rope member;
a second base member disposed on an upper side of the first looped rope member;
a first wall member formed so as to intersect the first base member on a circumferential edge portion of the first base member;
a second wall member formed so as to intersect the second base member on a circumferential edge portion of the second base member; and
a weight mounted on the second base member inside of the second wall member,
wherein the first looped rope member is fixed to the first base member and the second base member with the loop portion standing up, and
wherein the second looped rope member is fixed to the first wall member and the second wall member with the loop portion standing up.

4. The vibration damping apparatus according to claim 3,
wherein an inclination angle between a straight line, which connects a first fixing position of the second looped rope member to the first wall member and a second fixing position of the second looped rope member to the second wall member, and a horizontal plane is set in a predetermined range.

5. A vibration damping apparatus, comprising:
a first looped rope member and a second looped rope member each having a loop portion formed of a rope member in a loop shape, the rope member being formed by twining a plurality of linear members; and
a first base member and a second base member disposed in an up-and-down of the first looped rope member,
wherein the first looped rope member is fixed to the first base member and the second base member with the loop portion standing up, and
wherein the second looped rope member is fixed to a circumferential edge portion of one of the first base member and the second base member with the loop portion extending out and standing up.

6. The vibration damping apparatus according to claim 1,
wherein the first looped rope member and the second looped rope member are each formed in a helical shape having a plurality of the loop portions.

7. The vibration damping apparatus according to claim 2,
wherein the first looped rope member and the second looped rope member are each formed in a helical shape having a plurality of the loop portions.

8. The vibration damping apparatus according to claim 3,
wherein the first looped rope member and the second looped rope member are each formed in a helical shape having a plurality of the loop portions.

9. The vibration damping apparatus according to claim 4,
wherein the first looped rope member and the second looped rope member are each formed in a helical shape having a plurality of the loop portions.

10. The vibration damping apparatus according to claim 5,
wherein the first looped rope member and the second looped rope member are each formed in a helical shape having a plurality of the loop portions.

11. The vibration damping apparatus according to claim 1, further comprising:
a plurality of the second looped rope members disposed at equal intervals.

12. The vibration damping apparatus according to claim 2, further comprising:
a plurality of the second looped rope members disposed at equal intervals.

13. The vibration damping apparatus according to claim 3, further comprising:
a plurality of the second looped rope members disposed at equal intervals.

14. The vibration damping apparatus according to claim 4, further comprising:
a plurality of the second looped rope members disposed at equal intervals.

15. The vibration damping apparatus according to claim 5, further comprising:
a plurality of the second looped rope members disposed at equal intervals.

16. The vibration damping apparatus according to claim 2,
wherein the weight is constituted of a plurality of metal plates having same shapes and having depressions and projections formed in a surface.

17. The vibration damping apparatus according to claim 3,
wherein the weight is constituted of a plurality of metal plates having same shapes and having depressions and projections formed in a surface.

18. The vibration damping apparatus according to claim 4,
wherein the weight is constituted of a plurality of metal plates having same shapes and having depressions and projections formed in a surface.
